(19) United States
(12) Patent Application Publication
(10) Pub. No.: US 2009/0247063 A1
(43) Pub. Date: Oct. 1, 2009

(54) Solar powered vehicle ventilation system

(76) Inventor: Stanley Armin Vollertsen, Chandler, AZ (US)

Correspondence Address: Stanley A. Vollertsen, 25 W. Oakland St. #10, Chandler, AZ, 85225, US

(21) Appl. No.: 12/079,616

(22) Filed: Mar. 28, 2008

(51) Int. Cl. B60H 1/26; B60H 1/24; F24F 7/10

(52) U.S. Cl. 454/143; 454/338; 236/49.3

(57) ABSTRACT

When outside temperatures in the warmer months are high temperatures, inside a vehicle passenger compartment can be dangerously high while a vehicle is parked directly in the sun. There are several infant deaths caused by being left alone in the parked vehicle each year. A solar powered ventilation system is independent of the existing ventilation system of at least one fan and connected to a control system that has a thermostat and a disabling switch. The fan(s) is powered independently by the solar cell(s) or solar panel so as not to drain the vehicle's battery needlessly. The vehicle must be parked and off in order to operate the solar powered ventilation system.

### REFERENCES CITED

### Referenced by

U.S. Patent Documents

| | | |
|---|---|---|
| 4800803 | January 1989 | Farmont |
| 4804140 | February 1989 | Cantrell |
| 5038674 | August 1991 | Merges |
| 5040455 | August 1991 | Doi, et al. |
| 5205782 | April 1993 | Ohba |
| 5433660 | July 1995 | Ohba |
| 6158225 | December 2000 | Muto, et al. |
| 6290593 | September 2001 | Weussbrich, et al. |
| 6626003 | September 2003 | Kortum et al. |
| 6808450 | October 2004 | Snow |

### FIELD OF THE INVENTION

The present invention relates to the ventilation of a motorized vehicle passenger compartment while parked in the sun preventing excessive heating of the passenger compartment.

### BACKGROUND OF THE INVENTION

During the warmer months a vehicle passenger compartment of a vehicle parked in the sun can exceed 170 degrees Fahrenheit, compared to the outside temperature being at 105 degrees Fahrenheit. Children die every year due to being left inside a parked vehicle for this reason. With the solar powered ventilated vehicle interior polymer parts will last longer from not being exposed to the extreme heat of a conventional vehicle. This design would also apply for new vehicle construction. Also, upon getting into a vehicle to drive the vehicle after all day in the sun would take an appreciably less amount of time for the passenger compartment to reach room temperature (72 degrees Fahrenheit) once the vehicle is started.

### SUMMARY OF THE INVENTION

It is, therefore, a solar powered Ventilation system with one inside thermostat that is all that is needed. The solar panel supplies most of the power to the fan that prevents draining the vehicle battery electricity. The control system for the device is powered by the vehicles' battery, but not significant to cause problems with the battery of the vehicle.

### DESCRIPTION OF THE FIGURES

As shown in FIG. 1, a fan is mounted in the passenger door and nearby holes are drilled into the door for proper air flow. The exhaust of hot air in the passenger compartment is provided by the vehicle dampers being open to the outside when Normal or Vent is selected on the vehicles air conditioning controls.

FIG. 2 is a block diagram of the solar powered ventilation system. The vehicle's electrical system is input to the control system. Also the thermostat is input to the control system. The control system commands when the MOSFET allows the electricity to flow from the solar panel to the fan.

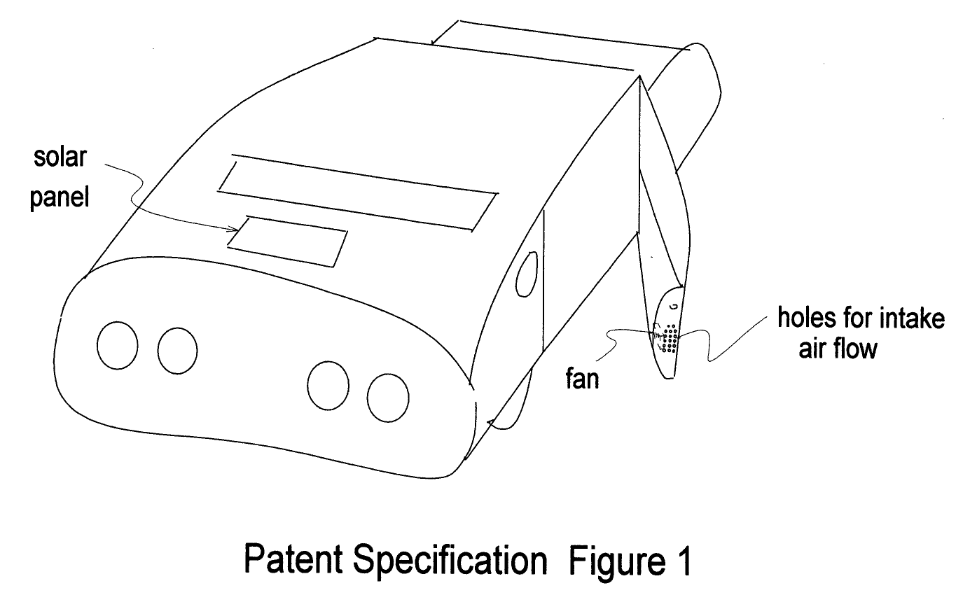

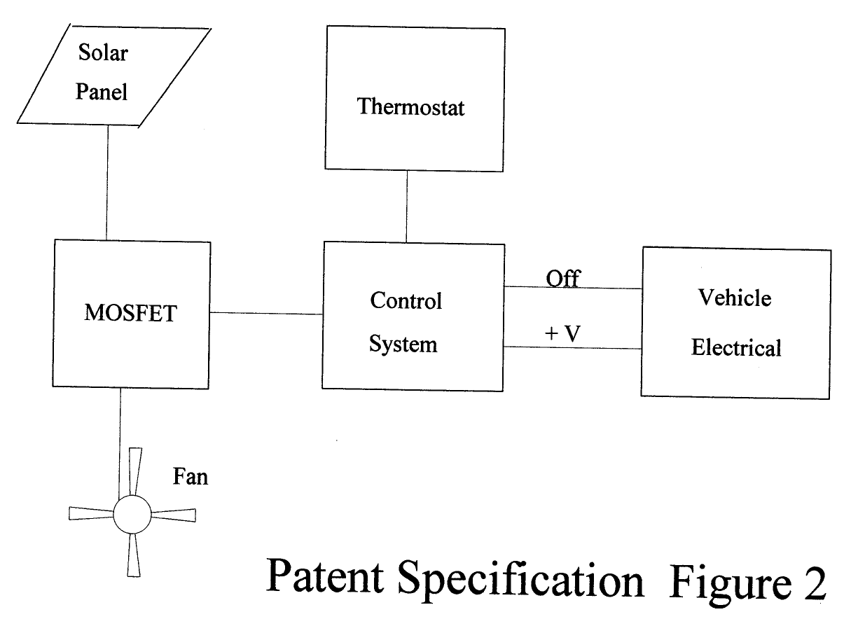

1. A solar powered ventilation system for a parked vehicle comprising:
At least one fan for an intake of outside air to cool the passenger compartment of the vehicle.
Solar cell(s) or solar panel to provide electrical power for the fan(s) absorbing sunlight and converting the sunlight to electricity.
A control section to automatically turn on the fan(s) when the temperature inside the passenger compartment is too high.

2. Extra holes are drilled in the body of the vehicle to allow for enough airflow for the ventilation system intake of outside air.

3. The control section is powered by the vehicle's electrical system with a minimal current drain of the vehicle's battery.

4. The fan(s) are powered directly by the solar panel so as not to drain the vehicle's battery of electricity.

5. The vehicle must be turned off with the vehicle air conditioning turned either to normal or vent in order to leave the vehicles outside air dampers open to complete the exhaust of air inside the passenger compartment.

6. The solar powered ventilation is only operational when the vehicle is parked and the ignition is off.

7. There is a thermostat as part of the control section that allows the solar powered ventilation system to operate only when the temperature inside the passenger compartment is above 80 degrees Fahrenheit.

8. There is a switch that disables the solar powered ventilation system during cooler months.
